(19) United States
(12) Patent Application Publication
(10) Pub. No.: US 2026/0162428 A1
(43) Pub. Date: Jun. 11, 2026

(54) SYSTEM AND METHOD FOR IDENTIFYING VIDEO CLIPS REPRESENTING PHOTOPLETHYSMOGRAM (PPG) SIGNAL

(71) Applicant: Jashna Oza, San Jose, CA (US)

(72) Inventor: Jashna Oza, San Jose, CA (US)

(21) Appl. No.: 18/969,331

(22) Filed: Dec. 5, 2024

(51) Int. Cl. G06V 20/40; G06T 7/00

(52) U.S. Cl. CPC G06V 20/46; G06T 7/0012; G06V 20/49; G06T 2207/10016; G06T 2207/20081; G06T 2207/30104

(57) ABSTRACT

The embodiments herein provide a method and a system for identifying video clips representing photoplethysmogram (PPG) signals. The method for identifying video clips representing PPG signals includes segmenting a video into video chunks of configurable duration, analyzing each frame within the video chunk for detecting the presence of red pixels indicative of blood flow and validating each frame in case percentage of red pixels exceeds a configurable threshold. The method further includes, screening the video chunks by determining percentage of invalid frames within each video chunk, and rejecting video chunks where the percentage of invalid frames exceeds a configurable threshold. The method further includes, identifying blood flow in valid video chunks, extracting one or more time-series signals from valid video chunks and applying signal processing techniques including wavelet matching to the time-series signal. The method further includes, validating the identified wavelets and adjusting parameters for optimising the identification and validation of PPG signals.

### FIELD

This invention relates to a system and method for identifying video clips representing photoplethysmogram (PPG) signal.

### BACKGROUND

Photoplethysmography (PPG) is a non-invasive optical technique widely used to monitor physiological parameters, such as heart rate, blood oxygen levels and respiratory rates, by detecting changes in blood volume within the microvascular tissue. Typically, a light source illuminates the skin, and a sensor measures variations in light absorption or reflection caused by pulsatile blood flow. PPG is commonly used in devices like pulse oximeters and wearable health monitors, and, more recently, in smartphones and other consumer electronics with integrated cameras.

Despite its benefits, accurately capturing PPG signals through video-based methods on consumer devices, especially smartphones, presents several challenges. Video recordings intended for PPG signal extraction are often subject to noise from ambient lighting conditions, variable skin contact, motion artifacts, and interference from non-skin scenes. These factors can degrade the quality of the captured data, resulting in inaccurate or unusable PPG signals. To ensure reliable health metrics from PPG analysis, it is essential to filter out irrelevant frames and enhance the detection of valid frames that clearly represent blood flow.

Traditional signal processing and noise reduction techniques are widely used to clean PPG signals by removing extraneous content. However, these methods face limitations when applied directly to video data, as visual noise in video recordings requires intensive frame-by-frame analysis to isolate frames that accurately represent blood flow. This process can be computationally demanding and time-intensive, which reduces the efficiency and effectiveness of video-based PPG signal extraction. Further, current systems for extracting PPG signals from video data are highly susceptible to motion artifacts and lack effective mechanisms for screening out frames impacted by such artifacts, resulting in compromised signal accuracy.

The existing systems find it challenging to differentiate between genuine blood flow signals and lighting artifacts, leading to unreliable data, especially in environments with variable lighting. Additionally, the existing systems often fail to assess and filter out frames with reduced quality caused by non-skin elements or insufficient skin contact, leading to the inclusion of non-informative or low-quality frames. Many existing systems do not analyze color content in each frame to confirm the presence of blood flow, allowing irrelevant frames without valuable data to be included. Moreover, these systems typically offer limited signal processing capabilities and do not conduct real-time screening of video segments for validity, which further impacts the reliability of the extracted PPG signals.

Therefore, a robust, adaptive, and automated solution is needed to address the issues of low reliability, low accuracy, and user inconvenience in capturing and analysis of PPG signals. Hence, there is a need for a system and method to reliably identify and validate PPG signals from video recordings, ensuring accuracy and usability across diverse conditions.

### SUMMARY

The above-mentioned shortcomings, disadvantages and problems are addressed herein, which will be understood by reading and studying the following specification.

### BRIEF DESCRIPTION OF THE DRAWINGS

Embodiments herein are illustrated in the accompanying drawings, throughout which like reference letters indicate corresponding parts in the various figures. The example embodiments herein will be better understood from the following description with reference to the drawings, in which:

FIG. 1 illustrates a block diagram showing different components of a system for identifying video clips representing photoplethysmogram (PPG) signals, in accordance with an embodiment of the present invention.

FIG. 2 illustrates a flowchart showing a method of identifying video clips representing photoplethysmogram (PPG) signals, in accordance with an embodiment of the present invention.

### DETAILED DESCRIPTION

The embodiments herein and the various features and advantageous details thereof are explained more fully with reference to the non-limiting embodiments and detailed in the following description. Descriptions of well-known components and processing techniques are omitted so as not to unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Some embodiments of this disclosure, illustrating all its features, will now be discussed in detail. The words “enabling”, “establishing”, and other forms thereof, are intended to be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof. The term “an embodiment” is to be read as “at least one embodiment.” The term “another embodiment” is to be read as “at least one other embodiment.” Although any system and methods similar or equivalent to those described herein can be used in the practice or testing of embodiments of the present disclosure, the exemplary system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The detailed description set forth below in connection with the appended drawings is intended as a description of various implementations of the present disclosure and is not intended to represent the only implementations in which details of the present disclosure may be applied. Each implementation described in this disclosure is provided merely as an example or illustration, and should not necessarily be construed as preferred or advantageous over other implementations.

There is a need for a system that addresses the problem of low accuracy and usability of video-based PPG monitoring. Further, there is a need for a system that can effectively identify relevant video clips representing true blood flow patterns, while filtering out extraneous or irrelevant content.

It must be understood that reference of any specific application in current disclosure, such as the physiological parameter measurement application, is merely provided for the ease of explanation, and should not be construed as a limiting factor for application of the methodologies described herein. Therefore, it is fairly possible for a person skilled in the art to utilize the details provided in current disclosure for any similar application.

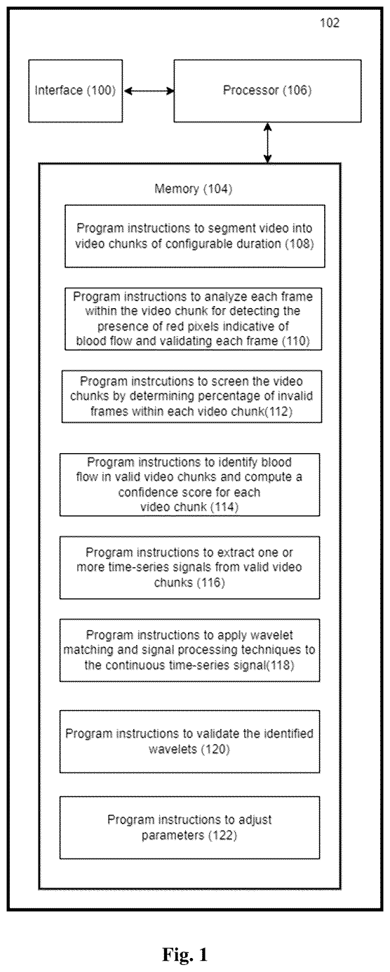

FIG. 1 illustrates a block diagram showing different components of a system 102 for identifying video clips representing photoplethysmogram (PPG) signals, in accordance with an implementation of the present invention. The system 102 includes the memory 104, the processor 106, and an interface 100. The memory 104 may store program instructions to perform several functions for identifying video clips representing photoplethysmogram (PPG) signals. For example, program instructions stored in the memory 104 may include program instructions to segment a video into video chunks of configurable duration 108, program instructions to analyze each frame within the video chunk for detecting the presence of red pixels indicative of blood flow and validating each frame 110, program instructions to screen the video chunks by determining percentage of invalid frames within each video chunk 112, program instructions to identify blood flow in valid video chunks and compute a confidence score for each video chunk 114, program instructions to extract one or more time-series signals from valid video chunks 116, program instructions to apply wavelet matching and other signal processing techniques to the continuous time-series signal 118, program instructions to validate the identified wavelets 120 and program instructions to adjust parameters 122.

The program instructions to segment a video into video chunks of configurable duration 108 may cause the processor 106 to segment a video into video chunks of configurable duration. The segmenting of the video may be performed during or after video recording. Alternatively, the video chunks of configurable duration may be generated by compilation of a series of images captured through ‘burst mode’. The program instructions to analyze each frame within the video chunk for detecting the presence of red pixels indicative of blood flow and validating each frame 110 may cause the processor 106 to analyze each frame within the video chunk for detecting the presence of red pixels indicative of blood flow and validating each frame in case percentage of red pixels exceeds a configurable threshold.

The program instructions to screen the video chunks by determining percentage of invalid frames within each video chunk 112 may cause the processor 106 to screen the video chunks by determining percentage of invalid frames within each video chunk. The video chunks are rejected when the percentage of invalid frames exceeds a configurable threshold thereby ensuring that valid video chunks consist of frames with sufficient red pixels. The program instructions to identify blood flow in valid video chunks and compute a confidence score for each video chunk 114 may cause the processor 106 to identify blood flow in valid video chunks and compute a confidence score for each video chunk. The confidence score computed may indicate the likelihood of identifying a PPG signal. The video chunks are accepted based on a configurable confidence threshold. The program instructions to extract one or more time-series signals from valid video chunks 116 may cause the processor 106 to extract one or more time-series signals from valid video chunks. Multiple extracted time-series signals are concatenated to form a continuous time-series signal for further analysis.

The program instructions to apply wavelet matching and other signal processing techniques to the continuous time-series signal 118 may cause the processor 106 to apply wavelet matching and other signal processing techniques to the continuous time-series signal. A wavelet analysis module may identify wavelets matching predefined PPG waveform templates. The accuracy of matching and the templates of the waveform may be configurable. The program instructions to validate the identified wavelets 120 may cause the processor 106 to validate the identified wavelets. A confidence score may be computed for each wavelet representing a PPG wavelet and an overall confidence score is computed for the continuous time-series signal representing a PPG waveform. The program instructions to adjust parameters 122 may cause the processor 106 to adjust parameters including video chunk duration, red pixel thresholds, luminance thresholds, invalid frame thresholds, machine learning confidence scores, and wavelet matching criteria. The adjusting of the parameters may be carried out for optimising the identification and validation of PPG signals.

In one embodiment, the processor further applies a machine learning algorithm for video activity recognition for determining whether the valid video chunk contains blood flow activity.

In another embodiment, the processor computes a confidence score indicating that the video chunk represents valid blood flow activity.

In yet another embodiment, the processor evaluates the time-series signal using a machine learning model trained to identify PPG waveforms, wherein the machine learning model provides a confidence score indicating that each segment of the time series signal represents a PPG waveform.

In yet another embodiment, the predefined video chunk duration is configurable based on different application requirements.

In yet another embodiment, the extraction of the time-series signal from the valid video chunks comprises applying noise cancellation techniques to remove artifacts from the time series signal.

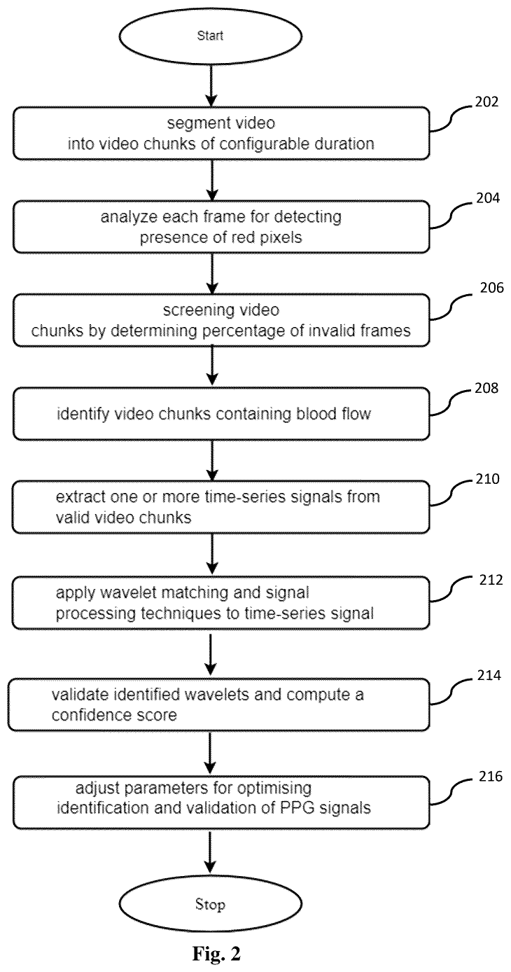

FIG. 2 illustrates a flowchart showing a method of identifying video clips representing photoplethysmogram (PPG) signals, in accordance with an implementation of the present invention. At step 202, a video is segmented into video chunks of configurable duration. The segmenting of the video may be performed during or after video recording. At step 204, each frame within the video chunk may be analyzed for detecting the presence of red pixels. The red pixels are indicative of blood flow and each frame may be validated in case percentage of red pixels exceeds a configurable threshold.

At step 206, the video chunks may be screened by determining percentage of invalid frames. The video chunks may be rejected when the percentage of invalid frames exceeds a configurable threshold thereby ensuring that valid video chunks consist of frames with sufficient red pixels. At step 208, video chunks containing blood flow may be identified. Further, a confidence score may be computed for each video chunk. The confidence score computed may indicate the likelihood of identifying a PPG signal. The video chunks may be accepted based on a configurable confidence threshold. At step 210, one or more time-series signals may be extracted from valid video chunks. Multiple extracted time-series signals may be concatenated to form a continuous time-series signal for further analysis. At step 212, wavelet matching and other signal processing techniques may be applied to time-series signal. A wavelet analysis module may identify wavelets matching predefined PPG waveform templates. The accuracy of matching and the templates of the waveform may be configurable. The signal processing techniques may include but not limited to wavelet matching and noise cancellation. The wavelet matching may be performed using conventional signal processing techniques or machine learning techniques.

At step 214, the identified wavelets may be validated and a confidence score may be computed for each wavelet representing a PPG wavelet and an overall confidence score may be computed for the continuous time-series signal representing a PPG waveform. At step 216, parameters for optimising identification and validation of PPG signals may be adjusted. The parameters may include video chunk duration, red pixel thresholds, luminance thresholds, invalid frame thresholds, machine learning confidence scores, wavelet matching criteria, etc. The adjusting of the parameters may be carried out for optimising the identification and validation of PPG signals.

In one embodiment, a machine learning algorithm is applied for video activity recognition for determining whether the valid video chunk contains blood flow activity and a confidence score indicating that the video chunk represents valid blood flow activity is computed.

In another embodiment, evaluating the time-series signal using a machine learning model trained to identify PPG waveforms, wherein the machine learning model provides a confidence score indicating that each segment of the time series signal represents a PPG waveform.

In another embodiment, the predefined video chunk duration is configurable based on different application requirements.

In yet another embodiment, extraction of the time-series signal from the valid video chunks comprises applying noise cancellation techniques to remove artifacts from the time series signal.

The method is illustrated in FIG. 2 as a collection of operations in a logical flow graph representing a sequence of operations that can be implemented in hardware, software, firmware or a combination thereof.

A main advantage of the present invention is that it combines traditional and modern techniques to curate and correctly identify relevant video data, enhancing the accuracy and reliability of PPG signal extraction by focusing on frames that truly represent blood flow. Another advantage of the present invention is that it optimizes computational efficiency by discarding irrelevant video data early in the processing pipeline. This pre-processing step ensures that only relevant data moves forward, reducing compute intensity and time requirements for physiological parameter calculations. Yet another advantage of the present invention is that it offers automated and adaptive pre-processing, adjusting parameters such as video chunk duration, red pixel thresholds, luminance levels, and wavelet matching criteria to suit diverse recording conditions, thereby optimizing video data for physiological analysis.

Still another advantage of the present invention is that it provides real-time screening and validation of video chunks, reducing the inclusion of invalid or low-quality frames. This selective pre-processing enhances both data quality and efficiency for subsequent physiological measurement. Yet another advantage of the present invention is that it applies advanced signal processing techniques, including wavelet matching and noise cancellation, to enhance the continuous time-series signal derived from curated video data, ensuring an accurate and clean PPG signal ready for physiological calculations. Still another advantage of the present invention is that it is robust to motion artifacts by identifying and rejecting video frames affected by movement and other parameters sensed by sensors built-in into smartphone or equivalent device, minimizing the impact of motion on signal quality and ensuring reliability even with minor movements during recording.

Yet another advantage of the present invention is that it is scalable and versatile, allowing it to be easily deployed across various video sources such as smartphones, wearables etc. and adaptable to a wide range of healthcare applications, making it suitable for diverse devices and use cases. Still another advantage of the present invention is that it uses confidence scores for video chunks and wavelet matches to ensure only high-confidence data is processed, increasing the reliability of extracted PPG signals and reducing the risk of irrelevant information. Yet another advantage of the present invention is that it reduces computational load by validating and rejecting low-quality video data at an early stage, making subsequent physiological analysis more efficient and resource-effective. Still another advantage of the present invention is that it is user-friendly and non-intrusive, optimized for mobile platforms and everyday devices such as smartphones, providing an easy and reliable method for obtaining physiological measurements with minimal user intervention.

The term “software” as used herein is intended to encompass such instructions stored in storage medium such as RAM, a hard disk, optical disk, cloud hosted or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on server or other location to perform certain functions.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

As used in the present specification, the term “machine learning” refers broadly to an artificial intelligence technique in which a computer's behavior evolves based on empirical data. In some cases, input empirical data may come from databases and yield patterns or predictions thought to be features of the mechanism that generated the data. Further, a major focus of artificial intelligence is the design of algorithms that recognize complex patterns and makes intelligent decisions based on input data. Artificial Intelligence may incorporate a number of methods and techniques such as; supervised learning, unsupervised learning, reinforcement learning, multivariate analysis, case-based reasoning, backpropagation, and transduction.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM class processor, a microprocessor, a digital signal processor, an application specific integrated circuit, a microcontroller, a state machine, or any type of programmable logic array.

A memory may include but is not limited to, non-transitory machine-readable storage devices such as hard drives, magnetic tape, floppy diskettes, optical disks, Compact Disc Read-Only Memories (CD-ROMs), and magnetooptical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

The foregoing description of the specific embodiments will so fully reveal the general nature of the embodiments herein that others can, by applying current knowledge, readily configure and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A method for identifying video clips representing photoplethysmogram (PPG) signals, comprising:
segmenting a video into video chunks of configurable duration, wherein the segmenting is performed during or after video recording;
analyzing each frame within the video chunk for detecting the presence of red pixels indicative of blood flow and validating each frame in case percentage of red pixels exceeds a configurable threshold;
screening the video chunks by determining percentage of invalid frames within each video chunk, and rejecting video chunks where the percentage of invalid frames exceeds a configurable threshold thereby ensuring that valid video chunks consist of frames with sufficient red pixels;
identifying blood flow in valid video chunks, wherein a confidence score is computed for each video chunk indicating the likelihood of identifying a PPG signal, and the video chunks are accepted based on a configurable confidence threshold;
extracting one or more time-series signals from valid video chunks, wherein multiple extracted and valid time-series signals are concatenated to form a continuous time-series signal for further analysis;
applying signal processing techniques including wavelet matching and noise cancelation to the continuous time-series signal, wherein a wavelet analysis module identifies wavelets matching predefined PPG waveform templates, with the matching accuracy and the waveform templates being configurable;
validating the identified wavelets, wherein a confidence score is computed for each wavelet representing a PPG wavelet, and an overall confidence score is computed for the continuous time-series signal representing a PPG waveform; and
adjusting parameters including video chunk duration, red and other color pixel thresholds, luminance thresholds, invalid frame thresholds, machine learning confidence scores, and wavelet matching criteria for optimising the identification and validation of PPG signals.

2. The method of claim 1, further comprising:
applying a machine learning algorithm for video activity recognition for determining whether the valid video chunk contains blood flow activity; and
computing a confidence score indicating that the video chunk represents valid blood flow activity.

3. The method of claim 1, further comprising:
evaluating the time-series signal using a machine learning model trained to identify PPG waveforms, wherein the machine learning model provides a confidence score indicating that each segment of the time series signal represents a PPG waveform.

4. The method of claim 1, wherein the predefined video chunk duration is configurable based on different application requirements.

5. The method of claim 1, wherein extraction of the time-series signal from the valid video chunks comprises applying noise cancellation techniques to remove artifacts from the time series signal.

6. A system for identifying video clips representing photoplethysmogram (PPG) signals, comprising:
one or more processors; and
one or more memories coupled with the one or more processors, the one or more memories storing programmed instructions, which when executed by the one or more processors, causes the one or more processors to:
segment a video into video chunks of configurable duration, wherein the segmenting is performed during or after video recording;
analyze each frame within the video chunk for detecting the presence of red pixels indicative of blood flow and validating each frame in case percentage of red pixels exceeds a configurable threshold;
screen the video chunks by determining percentage of invalid frames within each video chunk, and rejecting video chunks where the percentage of invalid frames exceeds a configurable threshold thereby ensuring that valid video chunks consist of frames with sufficient red pixels;
identify blood flow in valid video chunks, wherein a confidence score is computed for each video chunk indicating the likelihood of identifying a PPG signal, and the video chunks are accepted based on a configurable confidence threshold;
extract one or more time-series signals from valid video chunks, wherein multiple extracted and valid time-series signals are concatenated to form a continuous time-series signal for further analysis;
apply signal processing techniques including wavelet matching and noise cancelation to the continuous time-series signal, wherein a wavelet analysis module identifies wavelets matching predefined PPG waveform templates, with the matching accuracy and the waveform templates being configurable;
validate the identified wavelets, wherein a confidence score is computed for each wavelet representing a PPG wavelet, and an overall confidence score is computed for the continuous time-series signal representing a PPG waveform; and
adjust parameters including video chunk duration, red and other colour pixel thresholds, luminance thresholds, invalid frame thresholds, machine learning confidence scores, and wavelet matching criteria for optimising the identification and validation of PPG signals.

7. The system of claim 6, further comprising:
application of a machine learning algorithm for video activity recognition for determining whether the valid video chunk contains blood flow activity; and
computation of a confidence score indicating that the video chunk represents valid blood flow activity.

8. The system of claim 6, further comprising:
evaluation of the time-series signal using a machine learning model trained to identify PPG waveforms, wherein the machine learning model provides a confidence score indicating that each segment of the time series signal represents a PPG waveform.

9. The system of claim 6, wherein the predefined video chunk duration is configurable based on different application requirements.

10. The system of claim 6, wherein extraction of the time-series signal from the valid video chunks comprises applying noise cancellation techniques to remove artifacts from the time series signal.
